(19) United States
(12) Patent Application Publication
(10) Pub. No.: US 2022/0177366 A1
(43) Pub. Date: Jun. 9, 2022

(54) MANUFACTURING PORTLAND CEMENT WITH THERMAL PLASMA

(71) Applicant: University of Florida Research Foundation, Inc., Gainesville, FL (US)

(72) Inventors: Christopher Charles Ferraro, Gainesville, FL (US); Jerry M. Paris, Gainesville, FL (US); Juan Carlos Villatoro, Gainesville, FL (US); Timothy G. Townsend, Gainesville, FL (US)

(21) Appl. No.: 17/676,564

(22) Filed: Feb. 21, 2022

Related U.S. Application Data
(63) Continuation-in-part of application No. PCT/US2020/047472, filed on Aug. 21, 2021.
(60) Provisional application No. 62/889,708, filed on Aug. 21, 2019.

(51) Int. Cl. C04B 7/44; C04B 7/60

(52) U.S. Cl. CPC C04B 7/4453; C04B 7/60

(57) ABSTRACT

Various examples are provided related to manufacturing portland cement with thermal plasma. In one example, a method includes providing a raw kiln feed to a plasma arc gasification kiln; and forming clinker by heating the raw kiln feed in the plasma arc gasification kiln. The raw kiln feed can be heated with a plasma plume supplied with argon gas to a temperature in a range from about 1800° C. to about 3000° C. In another example, a system includes a kiln feed system and a plasma arc gasification kiln that receives raw kiln feed from the kiln feed system and heats the raw kiln feed with a plasma plume to form clinker. The system can include a clinker processing system configured to process the formed clinker to produce portland cement.

### CROSS REFERENCE TO RELATED APPLICATIONS

This application is a continuation-in-part application that claims priority to, and the benefit of, co-pending Patent Cooperation Treaty (PCT) international application No. PCT/US2020/047472, filed on Aug. 21, 2021, which claims priority to, and the benefit of, U.S. provisional application entitled “Manufacturing Portland Cement with Thermal Plasma” having Ser. No. 62/889,708, filed Aug. 21, 2019, all of which are hereby incorporated by reference in their entireties.

### BACKGROUND

Cement is a construction element produced in virtually all countries. Globally, over 150 countries produce cement or clinker, the primary ingredient of portland cement. Rotary kilns, which are core components of cement plants worldwide, produce 5-9% of global output of anthropogenic CO₂. The combustion of fossil fuels liberates about half of this amount. Given the projected growth of cement production and concerns over the amount of greenhouse gas that would be emitted, the industry is looking for alternatives that would reduce the total effective carbon footprint of cement manufacturing.

### SUMMARY

Embodiments of the present disclosure are related to manufacturing portland cement with thermal plasma. In one aspect, among others, a method for portland cement manufacture comprises providing a raw kiln feed to a plasma arc gasification kiln; and forming clinker by heating the raw kiln feed in the plasma arc gasification kiln. The raw kiln feed is heated with a plasma plume supplied with argon gas to a temperature in a range from about 1800° C. to about 3000° C. In one or more aspects, the method can comprise preparing cement from the clinker formed in the plasma arc gasification kiln. The plasma arc gasification kiln can be a high-temperature plasma arc reactor (HiPAR). The plasma arc gasification kiln can be an industrial cement production kiln. The raw kiln feed can comprise waste stream materials. The waste stream materials can be from a waste incineration process. The plasma plume can be ignited using helium gas and transitioned to the argon gas for formation of the clinker.

In another aspect, a system for portland cement manufacture comprises a kiln feed system and a plasma arc gasification kiln configured to receive raw kiln feed from the kiln feed system and heat the raw kiln feed with a plasma plume supplied with argon gas to a temperature in a range from about 1800° C. to about 3000° C., thereby forming clinker. The system can comprise a clinker processing system configured to process the formed clinker to produce portland cement. The plasma arc gasification kiln can be a high-temperature plasma arc reactor (HiPAR) or an industrial cement production kiln. The raw kiln feed can comprise waste stream materials, which can be from a waste incineration process. The system can comprise a kiln feed processing system configured to process the raw kiln feed for provision to the plasma arc gasification kiln by the kiln feed system. The kiln feed processing system can produce the raw kiln feed by mixing kiln feed from a plurality of sources. The kiln feed system comprises a kiln feed conveyor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 includes images of an example of a high-temperature plasma arc reactor (HiPAR), in accordance with various embodiments of the present disclosure.

FIGS. 2A and 2B are graphical representations illustrating an interior arrangement of the HiPAR of FIG. 1, in accordance with various embodiments of the present disclosure.

FIG. 2C is an image illustrating operation of the HiPAR of FIG. 1, in accordance with various embodiments of the present disclosure.

FIG. 3 illustrates an example of a raw kiln processing system, in accordance with various embodiments of the present disclosure.

FIG. 4 illustrates an example of raw kiln processing, in accordance with various embodiments of the present disclosure.

FIG. 5 is a table illustrating chemical oxide content of feedstock components, in accordance with various embodiments of the present disclosure.

FIG. 6 illustrates an example of temperature of specimen and ambient conditions within the HiPAR reactor during testing, in accordance with various embodiments of the present disclosure.

FIG. 7 illustrates a diffractogram of a specimen from the testing, in accordance with various embodiments of the present disclosure.

FIG. 8 is a table illustrating crystalline content of clinkers from the testing, in accordance with various embodiments of the present disclosure.

FIG. 9 illustrates a cumulative heat generation curve comparing plasma cements with varying amounts of gypsum additions to portland cement, in accordance with various embodiments of the present disclosure.

### DETAILED DESCRIPTION

Disclosed herein are various examples related to manufacturing portland cement with thermal plasma. Plasma arc gasification can offer a superior alternative to traditional rotary kiln production by, e.g., eliminating fuel-borne CO₂ emissions and/or overcoming barriers that can impede mainstream recycling of waste byproducts in cement manufacturing. By design the proposed plasma arc approach can remove the need for traditional fuel sources (e.g., oil, gas, coal), freeing cement plants to use grid power or battery banks powered by renewable sources, which can be onsite or offsite. Replacing the flame heat source with a plasma arc can also reduce the introduction of impurities, which should increase the tolerance for incorporating alternative precursors such as non-organic waste stream materials, further reducing the total effective carbon footprint of cement manufacturing. Reference will now be made in detail to the description of the embodiments as illustrated in the drawings, wherein like reference numbers indicate like parts throughout the several views.

The disclosed technology uses a high-temperature plasma arc reactor to generate the main ingredient of portland cement, clinker, in a highly controlled environment. The plasma torch can operate at temperatures up to 3000° C. (or about twice the temperatures produced by rotary kilns) to initiate phase formation reactions (e.g., alite or belite) and control their rate until clinker is formed. This operation can produce multi-phase materials that have the same phase composition as typical cement clinker produced by today's industrial processes.

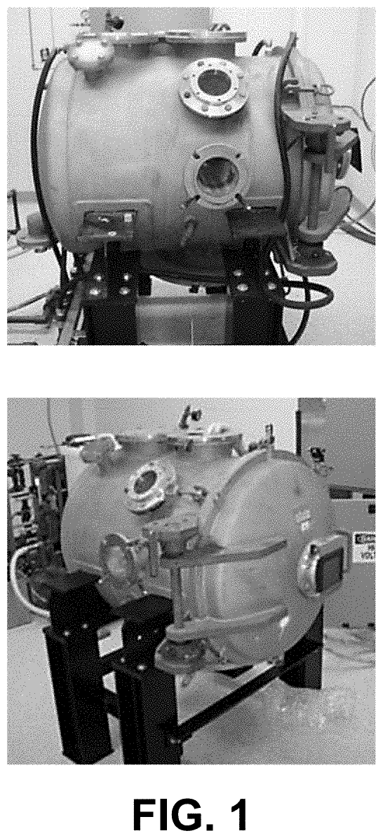

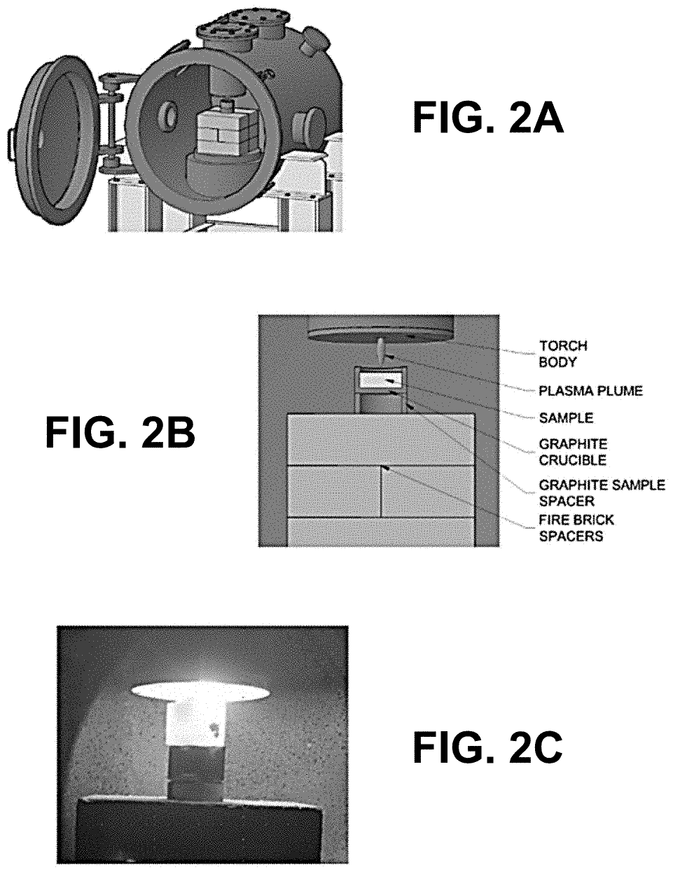

The process utilizes a high-temperature plasma arc reactor (HiPAR) to generate clinker, the main ingredient of portland cement, in a highly controlled environment. FIG. 1 shows images of a HiPAR (25 kW argon plasma torch system by Pyrogenesis Inc.) that can be utilized for manufacturing portland cement with thermal plasma. The plasma torch generates a flow of plasma to deliver energy to a specimen within the reactor. FIG. 2A illustrates the internal arrangement of the HiPAR, which is a non-transferred arc torch configured with both electrodes contained within a torch body. The plasma gas passes through the arc created between the electrodes and exits the torch as plasma. A swirling motion can be created inside the torch keeping the plasma flowing through the center of the torch, which can reduce or minimize erosion of the electrodes. A non-transferred arc torch allows for treatment of any material, regardless of electrical conductivity.

As illustrated in FIG. 2B, a plasma plume is directed to a sample of the raw mixture to generate the main ingredient of portland cement, clinker, in a highly controlled environment. FIG. 2C is an image illustrating operation of the HiPAR. The HiPAR allows for automation of the temperature profiling up to 3000° C. to initiate phase formation reactions (e.g., elite, belite) and control their rate until clinker forms. A helium fuel is used to ignite the plasma plume, and argon fuel is used to maintain the plasma torch flame. Preliminary findings have shown that HiPAR using these fuels can produce multi-phase materials that have the same phase composition as typical cement clinker produced by industry today.

An “idealized” clinker can be manufactured with HiPAR without the drawbacks present in a traditional rotary kiln. The drawbacks can include, e.g., contamination of clinker by fuel combustion residues, refractories, and effects of fluxing agents. The manufacture of “high-temperature” clinker formed at temperatures above traditional maximums (1600° C.) offers the potential to dramatically increase efficiency in the manufacture of portland cement.

The high temperature operation also facilitates that use of waste materials as nontraditional precursors for clinker production. The manufacture of optimized cement phases provide a pathway to overcome the current barriers that impede mainstream recycling of waste byproducts in cement manufacturing. The HiPAR can be used to introduce waste stream materials to manufacture cement phases with performance criteria equivalent to traditional portland cement clinker. The manufacture of portland cement clinker with partial (or even total) replacement of naturally mined raw materials with waste stream materials can divert waste stream materials from landfills, and reduce total effective carbon footprint from the cement industry. Rather than filling landfills with these waste stream materials, they can be added to the mix as nontraditional precursors and provided to the HiPAR for production of the idealized and non-traditional high-temperature clinker.

The crystallography and morphology of the idealized and high-temperature clinker mineral phases may be determined using x-ray diffraction (XRD) and scanning electron microscopy (SEM) for comparison with transitional feed materials. The mineralogical (phase) composition can be analyzed using a quantitative x-ray diffraction (QXRD) using, e.g., a Rietveld refinement technique.

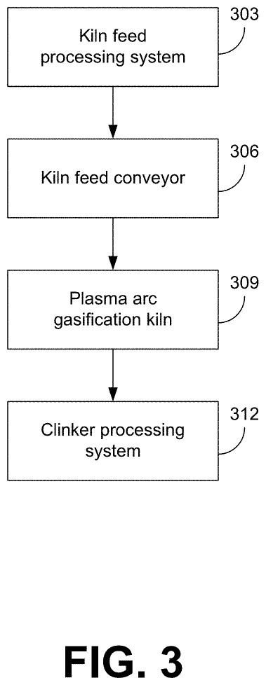

Referring to FIG. 3, shown is an example of a system for raw kiln processing. Raw kiln feed can be processed by kiln feed processing systems or equipment 303 before being supplied to a plasma arc gasification kiln 309 by a kiln feed conveyor 306. For example, the kiln feed can be crushed and/or sifted by the kiln feed processing equipment 303 to provide a more uniform kiln feed. The raw kiln feed can also be supplied from different sources, which can be mixed prior to supply to the plasma arc gasification kiln 309. The raw kiln feed can comprise waste stream materials, which can be from a waste incineration process. The raw kiln feed can be provided to the plasma arc gasification kiln 309 by a kiln feed conveyor 306 or other appropriate transport or supply systems.

The plasma arc gasification kiln 309 can be, e.g., a high-temperature plasma arc reactor (HiPAR) or an industrial cement production kiln. Clinker can be formed in the plasma arc gasification kiln 309 as previously described. The raw kiln feed can be heated with a plasma plume supplied with argon gas to a temperature in a range from about 1800° C. to about 3000° C. The plasma plume can be ignited using helium gas and transitioned to the argon gas for formation of the clinker. The clinker can then be processed by a clinker processing systems or equipment 312 to form cement from the clinker.

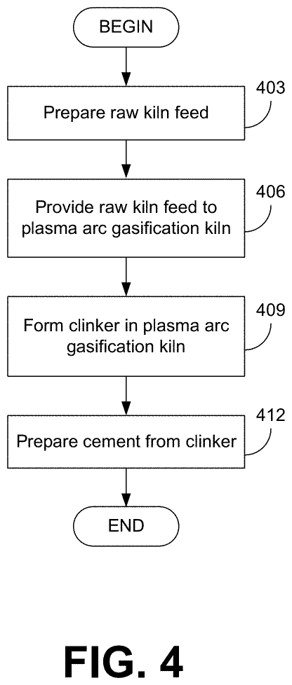

Referring to FIG. 4, shown is a flow diagram illustrating an example of the raw kiln processing. Beginning at 403, the raw kiln feed can be prepared for supply to the plasma arc gasification kiln 309 (FIG. 3). The raw kiln feed is provided to the plasma arc gasification kiln 309 by, e.g., a kiln feed conveyor 306 or other transport system at 406. Clinker is formed in the plasma arc gasification kiln 309 at 409. The resulting clinker can then be used to prepare cement at 412. This process offers the ability to utilize a wide range of raw kiln feed materials such as, e.g., waste materials as nontraditional precursors for clinker production. The process can reduce the total effective carbon footprint from the cement industry through the use of these non-traditional sources.

Cement Production with Plasma. As the cement industry moves toward the use of sustainable cements, the benefits of using a portland cement with a higher chemical efficiency produced at a higher kiln temperature may reduce the total clinker per unit weight of cement in a system that uses high amounts of portland cement. Studies regarding the use of plasma for the production of portland cement include computational modeling of the cement kiln using plasma as a heat source. The HiPAR is an instrument that was originally designed and primarily used for the conversion of municipal solid wastes into slag using plasma treatment.

Replacement Materials. Frequently, cement materials are supplemented with replacement waste-stream materials such as coal fly ash to reduce costs; however, the available supply of quality fly ash has been in decline while consumption has risen. Alternatives to portland cement materials have been commonplace within the industry for decades. Coal fly ash and blast furnace slag residuals from the power and steel industries, respectively, are the two most commonly used partial cement replacements. The utilization of waste in this way provides a two-fold benefit: it reduces the negative environmental impacts associated with the production of portland cement, and the replacements typically improve the long-term durability characteristics of the concrete produced. There have been reported shortages in conventional alternatives, which has raised concerns within the construction industry in the United States with respect to the availability of conventional alternatives in the long-term future. This has resulted in a return to reliance on traditional Portland cement. As the US transitions its power generation from coal to lower carbon alternatives, shortages in material alternatives for portland cement, especially fly ash, have become more frequent.

Alternative Kiln Fuels. Recycled materials for cement components have an added sustainable benefit, and they can also be partially substituted in kiln fuel. This part of the production process produces the majority of emissions and consumes 40-50% of the thermal energy of the process. Using alternative fuels like, biomass, waste petroleum products, and sewage sludge does not significantly reduce the carbon produced by cement manufacture, but it can provide higher thermal efficiency and diminish the carbon footprint of other waste streams. Furthermore, the use of recycled concrete waste materials like recycled concrete though the avoidance of de-carbonation of limestone feedstock. However, the substitution and material properties utilized are not uniform among manufacturers. Use of alternative fuels can also cause instability and unpredictability in flame size, heat produced, and quality of final clinker product and can further produce blockages and buildups in the production plant. One advantage is that, while it does require retrofitting to the plants, the alterations are less invasive and expensive than some other carbon reduction solutions like carbon capture.

Carbon Dioxide Sequestration. The sequestration of CO₂ offers another solution toward mitigating the negative effects of climate change. This involves the capture of carbon emissions during or after the cement production using methods such as amine scrubbing, calcium looping, or partial oxy-fuel combustion. Several analyses suggest that carbon capture may be one of the most impactful methods of emissions reduction for the industry, but this back-end solution has its own set of problems. The implementation of carbon capture and storage (CCS) in the cement industry is underdeveloped, with a total global rate of 40 Mt/yr in 2020, with the total production of CO₂ globally at approximately 36 Gt/yr. Thus, CCS currently accounts for 0.1% of total CO₂ production worldwide. This availability of this technology will need to increase dramatically to meet climate change needs. There are also negative externalities associated with storing large volumes of CO₂, including triggering of earthquakes and leaking of CO₂ from injection sites, which can result in additional negative environmental effects. In evaluating the different methods of carbon capture, consideration should be given to the avoidance of CO₂ production as a primary initiative.

Plasma Technology. Thermal plasma technology covers a broad application spectrum on both the industrial and research scale which include arc welding, cutting, coating techniques, powder densification, production of metals, synthesis of fine powders, and treatment of waste materials. Plasma is a unique, energy dense state of matter consisting of ions, as well as free electrons. Thermal plasma is created when matter, usually gas, is heated to extremely high temperatures. Thermal plasmas can be generated using transferred electric arcs, where one of the electrodes (usually the anode) is separated from the cathode or non-transferred where multiple rod electrodes are used to generate the plasma arc.

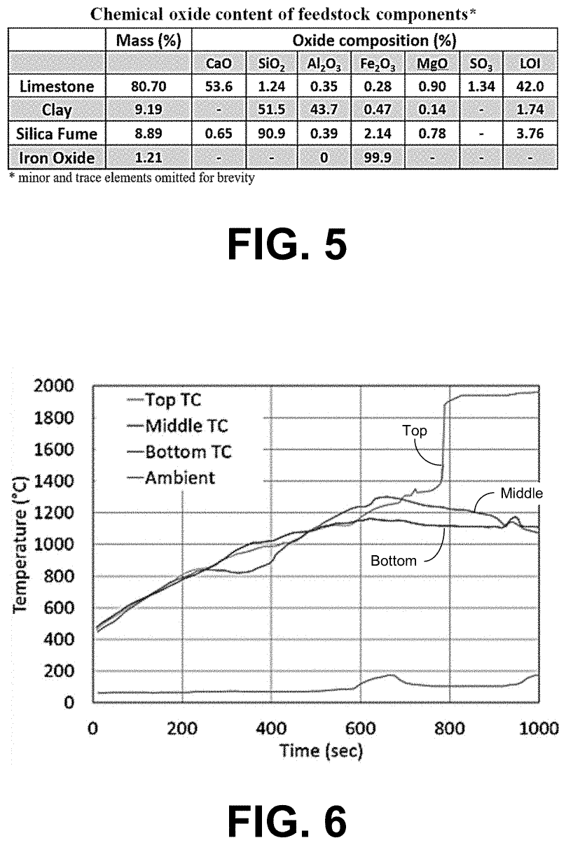

Preliminary Experimentation. To evaluate the viability of manufacturing portland cement clinker using thermal plasma, a series of laboratory experiments were performed using a laboratory-scale plasma arc testing unit. To obtain the desired mineral composition of clinker, the use of the requisite feedstock components to create a mixture of calcareous, aluminous, siliceous, and ferrous materials was needed. For this experiment, the use of limestone, clay, silica fume, and iron oxide were appropriate. Table of FIG. 5 summarizes the quantity of chemical composition of each feedstock component.

Subsequent to analysis, the mixture of feedstock components was thermally treated in two stages. The first stage involved the de-carbonation of the limestone materials in a muffle furnace where the raw materials were exposed to a temperature of 1000° C., ensuring de-carbonation of the limestone and stability of the materials in the plasma reactor. The raw materials were then pressed into 50 g cylinders. The second stage of thermal treatment comprised the placement of the de-carbonated limestone and the other raw mix ingredients into a crucible, followed by direct exposure to the thermal plasma source. Two trials of treatment with the plasma torch of 10 and 15 minutes using 2.25 kW-hr, and 2.75 kW-hr of energy for specimens 1 and 2, respectively.

The procedure and specimen are illustrated in FIG. 2C which shows the treatment of raw materials with thermal plasma in the HiPAR, where a maximum temperature of approximately 1950° C. was recorded. FIG. 6 plots the temperature of specimen and ambient conditions within the HiPAR reactor. The thermocouples were rated to 1700 C, the exact maximum temperature is not known. However, the temperature of the specimen was recorded to be in excess of 1400° C., known to result in the formation of portland cement clinkers. Upon cessation of the thermal plasma, the specimen was left to cool in the plasma reactor for approximately 15 minutes before it was removed from the crucible and stored for analysis. Approximately 50 g of clinker was produced from the initial experiment and the sample was analyzed, after which several iterations of balancing the system with gypsum was performed.

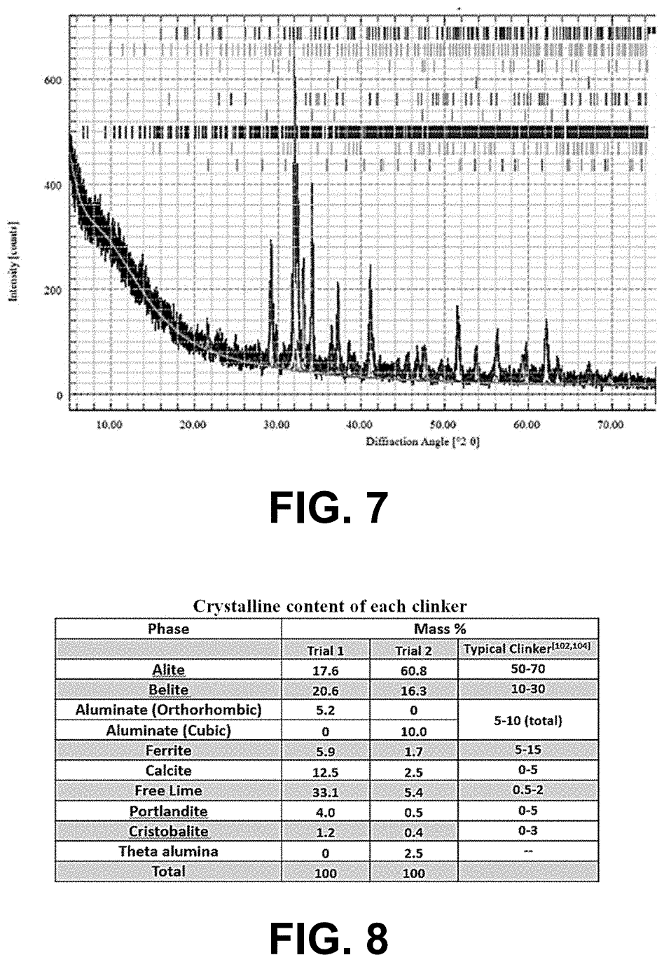

XRD Equipment, Software, and Mineralogical Results. The mineralogical composition of the resultant portland cement clinker was analyzed using semi-quantitative X-ray diffraction (SQXRD) via Rietveld refinement. Samples were scanned over a range of 5° to 90° 2θ. FIG. 7 illustrates a diffractogram of specimen #2. The instrument used to collect the scans was a Panalytical X-PERT Powder diffractometer equipped with an X'Celerator line array detector. Compositional analysis of the resulting scans was determined using Rietveld refinement with the Profex software package, which includes a standard library of structure files for many common minerals, including those found in portland cement.

The results from the SQXRD analysis are provided in the table of FIG. 8. The lower energy input into the Trial 1 resulted in a higher proportion of dicalcium silicate (belite); which is indicative of lower melt temperatures. Additionally, the presence of theta-alumina in Trial 2 indicates that the stable form of alumina present in the clay feed stock was melted and quickly quenched to form a meta-stable theta-alumina polymorph and the crystalline structure was similar to that of typical portland cement. Trial 1 did not reach temperatures high enough to melt the alpha-alumina resulting in a relatively large presence of free-lime. In HiPAR, specimens cool much more rapidly than in a rotary kiln due to the heat source being extinguished immediately and the small thermal mass of the sample.

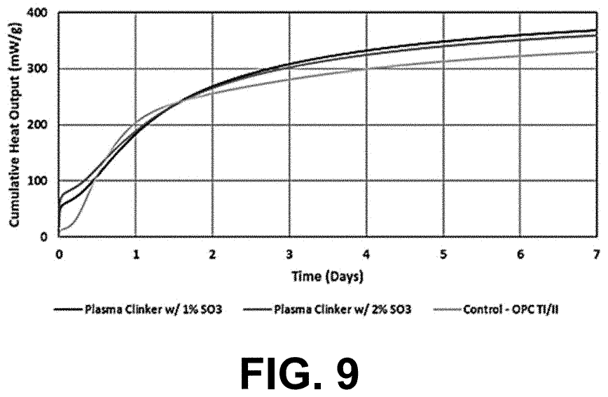

Hydration of Plasma Clinker. The clinkers produced by the plasma reactor were combined with varying amounts of gypsum to replicate the production of typical portland cement. The resultant cements were placed into an isothermal conduction calorimeter where the measurement of heat of hydration for cementitious materials was conducted. The test utilized a Tam-Air isothermal conduction calorimeter to precisely measure heat evolution of chemical reactions of hydrating cement paste within a temperature-controlled cell. The method has been standardized for the measurement of heat produced during the reaction of cement with water. The plasma cements were compared to a typical portland cement as shown in FIG. 9. While the initial heat release is notably higher than a typical portland cement, this is the heat of dissolution and is indicative of the gypsum material being more available or reactive than gypsum present in typical portland cement. The cumulative heat is very similar for the first three days, after which the plasma cement continues producing heat as a result of continued hydration.

Results. The results from the trial experiments prove the viability of the producing portland cement using the HiPAR where thermal plasma serves as the heat source and without fossil fuels and a traditional flame-heated kiln. The results from the initial experiments provide support for the proof-of-concept for producing portland cement clinker using a transferred arc plasma torch (TAT). This is the first known instance where TAT has been used to produce portland cement. Use of HiPAR at an industrial scale includes analysis of clinker production, zonal temperature mapping, and/or LCA to facilitate the scalability of the plasma system.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method for portland cement manufacture, comprising:
providing a raw kiln feed to a plasma arc gasification kiln; and
forming clinker by heating the raw kiln feed in the plasma arc gasification kiln, where the raw kiln feed is heated with a plasma plume supplied with argon gas to a temperature in a range from about 1800° C. to about 3000° C.

2. The method of claim 1, further comprising preparing cement from the clinker formed in the plasma arc gasification kiln.

3. The method of claim 1, wherein the plasma arc gasification kiln is a high-temperature plasma arc reactor (HiPAR).

4. The method of claim 1, wherein the plasma arc gasification kiln is an industrial cement production kiln.

5. The method of claim 1, wherein the raw kiln feed comprises waste stream materials.

6. The method of claim 5, wherein the waste stream materials are from a waste incineration process.

7. The method of claim 1, wherein the plasma plume is ignited using helium gas and transitioned to the argon gas for formation of the clinker.

8. A system for portland cement manufacture, comprising:
a kiln feed system;
a plasma arc gasification kiln configured to receive raw kiln feed from the kiln feed system and heat the raw kiln feed with a plasma plume supplied with argon gas to a temperature in a range from about 1800° C. to about 3000° C., thereby forming clinker; and
a clinker processing system configured to process the formed clinker to produce portland cement.

9. The system of claim 8, wherein the plasma arc gasification kiln is a high-temperature plasma arc reactor (HiPAR).

10. The system of claim 8, wherein the plasma arc gasification kiln is an industrial cement production kiln.

11. The system of claim 8, wherein the raw kiln feed comprises waste stream materials.

12. The system of claim 11, wherein the waste stream materials are from a waste incineration process.

13. The system of claim 8, comprising a kiln feed processing system configured to process the raw kiln feed for provision to the plasma arc gasification kiln by the kiln feed system.

14. The system of claim 13, wherein the kiln feed processing system produces the raw kiln feed by mixing kiln feed from a plurality of sources.

15. The system of claim 13, wherein the kiln feed system comprises a kiln feed conveyor.
